(19) United States
(12) Patent Application Publication
(10) Pub. No.: US 2018/0185992 A1
(43) Pub. Date: Jul. 5, 2018

(54) BOX WRENCH FOR STRIPPED NUTS AND BOLTS

(71) Applicant: Charles B. Mansfield, Copemish, MI (US)

(72) Inventor: Charles B. Mansfield, Copemish, MI (US)

(21) Appl. No.: 15/829,879

(22) Filed: Dec. 2, 2017

Related U.S. Application Data
(60) Provisional application No. 62/440,793, filed on Dec. 30, 2016.

(51) Int. Cl. B25B 13/50; B25B 27/18; B25B 23/00

(52) U.S. Cl. CPC B25B 13/50; B25B 23/0028; B25B 27/18

(57) ABSTRACT

A box wrench for stripped nuts, with a handle pivotally connected to a box head having a multi-point gripping ring contour. The gripping ring contour has a fixed major portion of regular points, and a rocker portion on a terminal end of the handle protruding into the box head. The rocker portion defines a minor asymmetric portion of the gripping ring, and is movable between a neutral position aligned with the remainder of the gripping ring, and a grip position misaligned with the remainder of the gripping ring and with an irregular point extended into the space inside the gripping ring to wedge or cam against a stripped nut.

### RELATED APPLICATIONS/PRIORITY BENEFIT CLAIM

This application claims the benefit of U.S. Provisional Application No. 62/440,793, filed Dec. 30, 2016 by the same inventor (Mansfield), the entirety of which provisional application is hereby incorporated by reference.

### FIELD

The subject matter of the present application is in the field of wrenches, in particular box-end wrenches (sometimes referred to as closed-end wrenches or ring spanners).

### BACKGROUND

“Box” or box-end wrenches have a fully enclosed aperture in the box head that grips the faces of a bolt head or nut (hereafter collectively “nut” for convenience). The ring generally has a circular shape with an even, symmetrical array of six-point or twelve-point interior gripping ring for engaging the six corners of hexagonal nuts and bolt heads. The twelve-point gripping ring fits onto the six corners of a nut or bolt at twice as many angles, an advantage where movement of the wrench handle to tighten or loosen the nut is limited. Eight-point box wrenches are also made for square-shaped nuts and bolt heads and operate on a similar nut-gripping principle.

Nuts whose corners have been rounded off or “stripped” are difficult to remove. Stripped nuts are typically caused by wear due to frequent tightening and loosening, corrosion, using incorrectly sized wrenches, or other damage.

Numerous wrenches have been proposed in the prior art for dealing with the problem of stripped nuts. One class of prior art box wrenches uses a spring-biased pawl nested in the wrench head and extending through an interruption in the gripping ring contour to increase gripping force against the nut. Potential problems include manufacturing complexity, moving parts and springs subject to wear from dirt and grease, and lack of strength for gripping severely stripped nuts. Examples include those wrenches shown in U.S. Pat. No. 2,514,687 to Werner; U.S. Pat. No. 2,602,362 to Johns; and U.S. Pat. No. 8,904,908 to Luhman.

Another class of box wrenches intended for increased gripping force on stripped nuts uses roughened or serrated surfaces on the inside faces and/or corners of the multi-pointed gripping ring contour. Examples include those shown in U.S. Pat. No. 3,903,764 to Andersen; U.S. Pat. No. 6,098,501 to Sundstrom; and U.S. Pat. No. 7,168,347 to Hsieh. These are believed to be of limited effectiveness for severely stripped nuts.

### BRIEF SUMMARY

The present invention is a box wrench for tightening and loosening severely stripped nuts as easily as undamaged nuts. The wrench is simple and strong, with few moving parts and a wide range of adaptability.

In a first form, the wrench has a handle with a box head pivotally mounted at a pivot point near the end of the handle. The box head has an inner gripping ring comprising a pattern of nut-engaging points suitable for the intended nut geometry (for example, a twelve-point pattern configured for a six-sided nut). A first major portion of the gripping ring is fixed, and interrupted by a terminal end or tip of the wrench handle extending above the pivot point through an aperture in the lower portion of the box head. The tip of the wrench handle is contoured to define a second minor “rocker” portion of the gripping ring, movable relative to the box head and having an asymmetric point contour that cooperates with the fixed portion of the gripping ring.

When the handle is in a neutral position ready to be applied to a nut, the rocker tip of the handle functions as a continuation of the fixed portion of the gripping ring, with the asymmetric point contour cocked at an angle to form an essentially normal continuation of the points in the major fixed portion of the gripping ring. If the nut is undamaged with good corners, the wrench functions as a normal wrench. If the nut is stripped, the handle and its rocker tip in the box head rotate from the neutral position to a gripping position as the handle is rotated, with the asymmetric portion of the rocker tip rotating out of alignment with the main fixed portion of the gripping ring and wedging against the nut so that torque is firmly applied without slipping.

In a further form, the asymmetric rocker tip at the end of the handle comprises a first higher point with a radiused upper cam surface, and a vertical side stop surface engaging a first stop in the handle aperture adjacent a first end of the major fixed portion of the gripping ring. The rocker tip further comprises a second lower (relative to the handle axis) point, with a flattened or rounded peak similar to the other points in the gripping ring, and with an angled side stop surface for engaging a second shallower stop in the handle aperture adjacent a second end of the fixed portion of the gripping ring. When the handle is rotated to tighten or loosen a stripped nut, the higher radiused point in the rocker tip rotates up into the gripping ring and is wedged or cammed against the nut to rotate the nut without slipping.

These and other features and advantages of the invention will become apparent from the detailed description below, in light of the accompanying drawings.

### BRIEF DESCRIPTION OF THE DRAWINGS

FIG. 1 is a front elevation view of an exemplary wrench according to the invention, showing the handle in a neutral or initial nut-engaging position.

FIG. 2 is similar to FIG. 1, but with the box head of the wrench sectioned vertically.

FIG. 3 is similar to FIG. 1, but shows the handle in a rotated camming or gripping position for engaging a stripped nut (phantom lines).

FIG. 4 is similar to FIG. 3, but with the box head of the wrench sectioned vertically.

FIG. 5 is an exploded assembly view of the wrench of FIG. 1.

### DETAILED DESCRIPTION

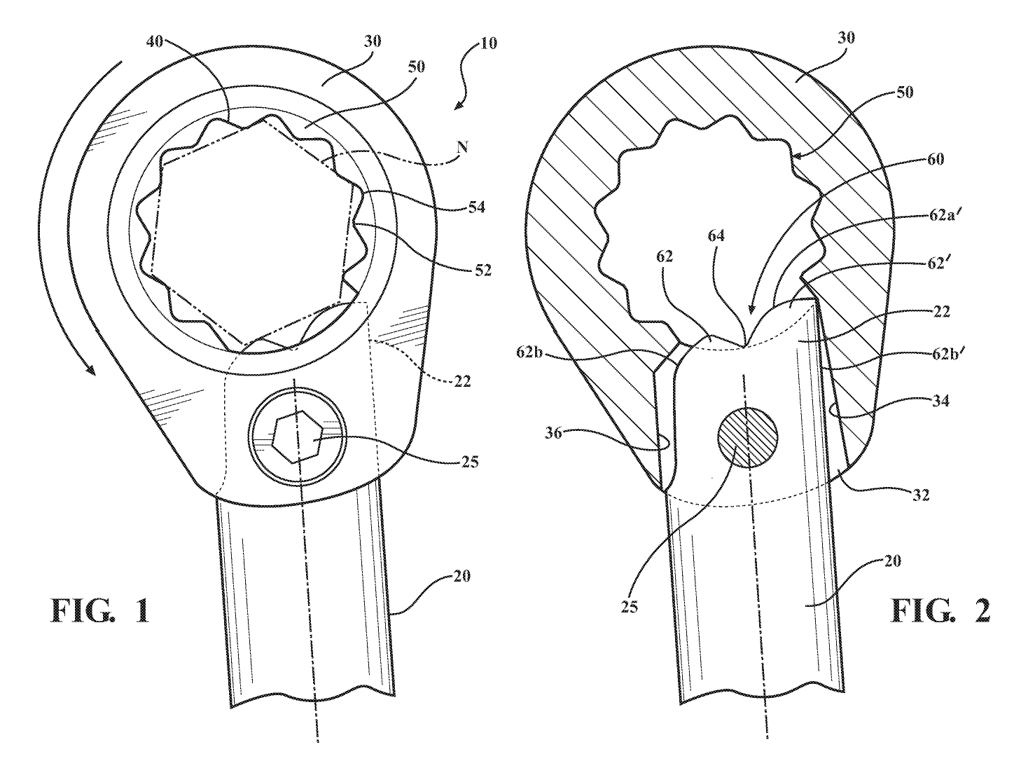

FIG. 1 shows an example box wrench 10 according to the invention in order to teach how to make and use the claimed invention. Wrench 10 includes a handle 20 and a box head 30 with a gripping ring 40 having a nut-gripping contour of rounded or flattened points and depressions, the majority of which are contained in a fixed gripping ring portion and are conventionally shaped. In the illustrated example, gripping ring 40 has a twelve-point contour for gripping hexagonal nuts.

Box head 30 is pivotally mounted on handle 20 by a pivot connection 25, for example a roll-pin, set screw with smooth intermediate shank section, bushing, pivot pin, or other type of rotating connection. Box head 30 and handle 20 may be made largely or entirely of hardened steel, in known manner, although other materials might be possible. The gripping ring contact surfaces could be made of a softer material than the remainder of the box head and handle, for example brass or hardened leather or rubber for different gripping characteristics, although conventional hardened steel is currently preferred.

The pivot connection 25 may be capable of disassembly in order to separate the box head 30 from handle 20 for cleaning, repair, or replacement, as shown for example in FIG. 5, where the pivot connection 25 comprises a bolt or set screw 25a extending through bore 25b in the lower end of the box head 30 and a corresponding bore 20b in handle 20 to engage threads in bore 25b on the opposite sides of the box head. The ends of screw 25a (or other pivot connection fastener) should fit flush or recessed with respect to the faces of box head 30, allowing the wrench head to fit better into tight spaces. Handle 20 remains free to rotate about the intermediate portion of screw 25a in bore 20b.

The terminal end or tip 22 of handle 20 extends through a corresponding aperture or slot 32 formed in the lower end of box head 30, with an uppermost portion of tip 22 extending up to the circumference of the gripping ring in the handle's neutral or nut-engaging position shown in FIGS. 1 and 2. Tip 22 selectively abuts stop surfaces 34, 36 formed at the sides of aperture 32 to limit box head rotation relative to the handle so that it pivots only through a controlled, limited arc. In the illustrated example, box head 30 pivots through an arc of approximately 15-20°, although this arcuate angle may vary depending on factors such as the size of the box head, the width of the handle and its tip, and the range of nut sizes expected to be encountered, by way of non-limiting example.

In the illustrated example, box head 30 is free to pivot about connection 25 relative to the handle without any bias one way or the other. No springs are necessary for the convenient and proper functioning of wrench 10, as will become apparent below. However, it would be possible to insert a biasing member between the box head 30 and handle 20, if desired, to predispose the handle and head to a particular position (for example, the neutral nut-engaging position of FIGS. 1 and 2) before force is applied to the handle.

Gripping ring 40 comprises two sections. The main or major section is a fixed section 50 comprising a majority of the circumference and gripping contour of the ring as a whole, in the illustrated example ten points 52 alternating with a corresponding number of depressions 54. The point and depression contour or geometry may be a standard or known type used for box wrenches.

The secondary or minor section of gripping ring 40 is a rocking or pivoting section 60 defined by a multi-point contour 62, 64 formed or mounted on the tip 21 of handle 20. The number of points 62 on rocker tip section 60 is sufficient to complete the gripping ring as a whole, and in the illustrated example comprises two points 62 and one depression 64 defined therebetween.

In the illustrated example, rocker tip section 60 is formed by casting, forging, or machining teeth 62 and depression(s) 64 directly into the steel of handle 20. If other materials are used for the handle, for example reinforced polymers, rocker tip section 60 could be formed by molding. Alternately, rocker tip section 60 could be formed separately and attached as an insert or cap onto tip 21 at the end of the handle; brazing, welding, insert-molding and other techniques would likely be suitable for doing so depending on the respective materials of handle tip 21 and the rocker tip section 60.

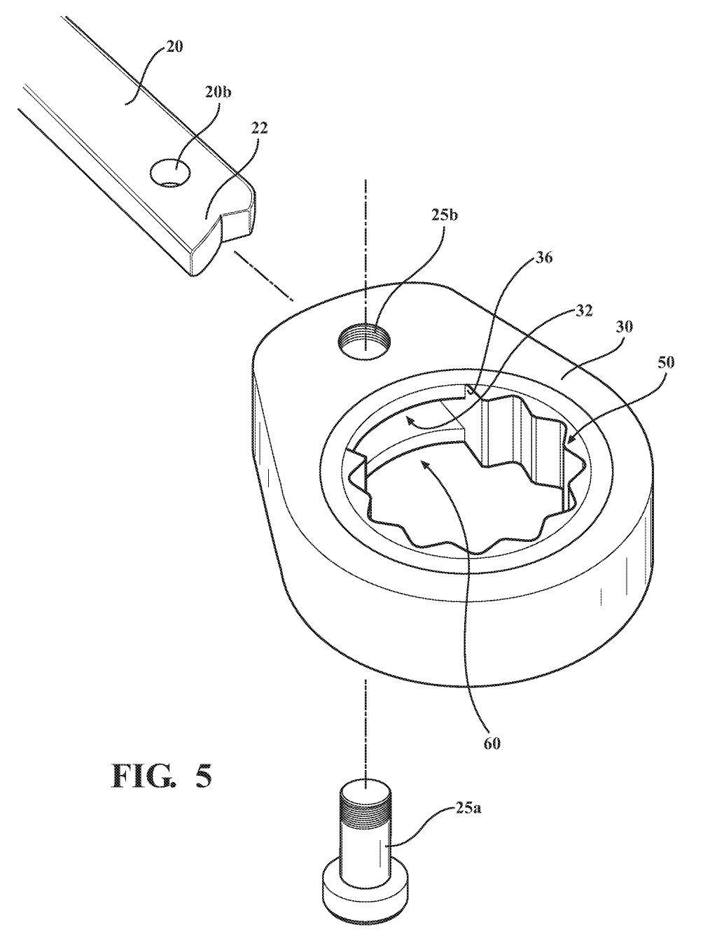

Referring now to FIGS. 2 and 4, points 62 in rocker tip section 60 comprise an asymmetric pair, with one regular point 62 corresponding substantially in shape and size to points 52 in the remainder of the gripping ring, and having an outer side 62b with an outwardly sloping angle or radius similar to that of the other points 52 in the gripping ring relative to the axis or adjacent side of handle 20. Rocker tip section also comprises an irregular or asymmetric cam point 62′ having a greater height as measured along the handle axis, and a rounded upper cam surface 62a′ terminating at a flat side 62b′ substantially parallel to the axis or adjacent side of handle 20.

Outer side 62b of regular point 62 comes into interfering contact with the shallower stop 36 on one side of the handle aperture 32 in the box head at one end of the box head's pivoting arc. The outer side 62b′ of irregular point 62′ comes into interfering contact with the longer stop 34 on the other side of handle aperture 32 at the other end of the box head's pivoting arc. It can be seen from the Figs. that the shallower, shorter stop surface 36 and the longer, steeper stop surface 34 are angled with respect to the box head so that the axis of handle 20 is cocked or off-axis with respect to the center of the box head aperture in the neutral nut-engaging position of FIGS. 1 and 2. Shorter stop surface 36 is “shallower” than longer stop surface 34 in the sense that it is differently-angled relative to a vertical axis Y through aperture 32 when the head is in the neutral nut-engaging position of FIGS. 1 and 2, the stop surfaces being non-parallel and diverging toward the bottom of the aperture as shown in the Figs., which provides a proper rocking range of motion for the rocker tip 60 in the aperture relative to the fixed portion of the gripping ring.

FIGS. 1 and 2 represent the wrench's neutral position, in which handle 20 and box head 30 are positioned so that teeth 62, 62′ of the handle's rocker tip section 60 form an essentially regular, normal continuation of the major portion 50 of gripping ring 40 as viewed above handle aperture 32. In this neutral position the flat outer side 62b′ of irregular cam point 62′ abuts stop 34.

Box head 30 is applied to a nut in the neutral position. If the nut N in gripping ring 40 is a normal, undamaged nut with intact corners, wrench 10 functions like a normal wrench, with all points and depressions of gripping ring 40 in fixed section 50 and rocker tip section 60 engaging the nut essentially equally (those skilled in the art will recognize that a minor amount of “play” or tolerance is considered normal for standard box wrenches, even with a perfect nut).

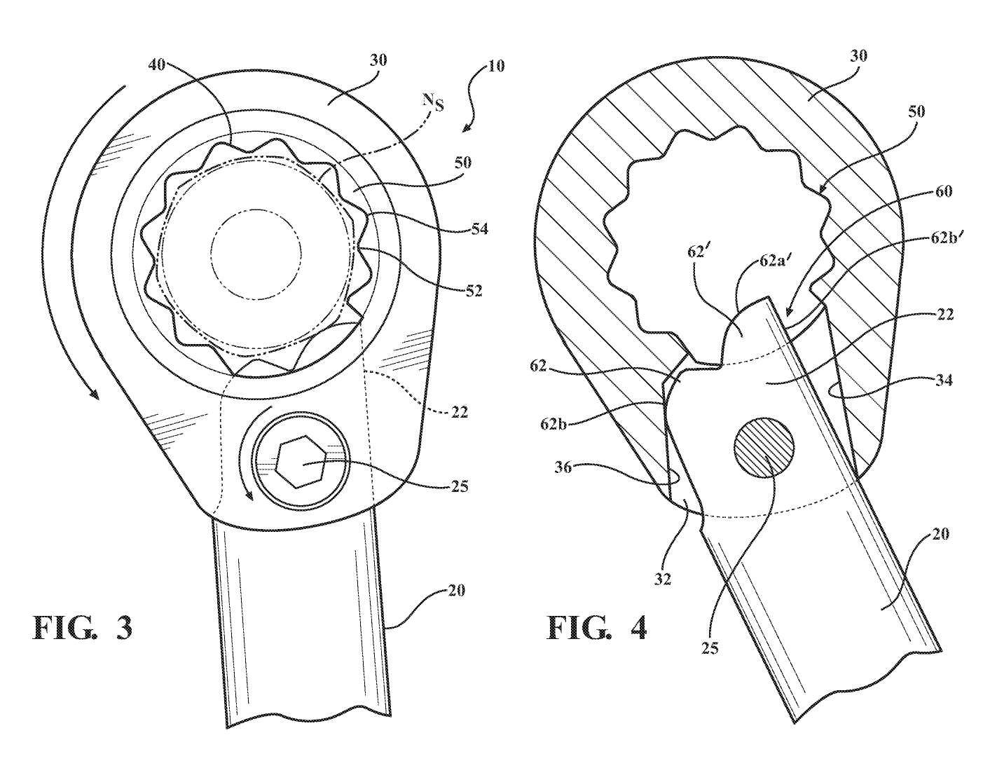

FIGS. 3 and 4 represent the wrench's gripping position for stripped nuts. If the nut engaged by gripping ring 40 is stripped as shown in FIG. 3, for example as shown at Ns with severely rounded corners effectively reducing its diameter or width, handle 20 will rotate relative to box head 30 as an attempt is made to tighten or loosen the nut. Regular point 62 will rotate down and out of circumferential alignment with fixed gripping section 50 into aperture 32 toward stop 36, while irregular point 62′ will rotate up and into the interior of the gripping ring until it engages a side of the nut Ns. At this point the rounded cam face 62a′ of irregular point 62′ is smoothly wedged into tight frictional contact with the side of the nut, the handle locks up relative to the box head, and torque is applied to the nut to tighten or loosen it without slipping.

FIG. 3 shows the wrench handle 20 rotated partway to engage a moderately stripped nut. FIG. 4 shows handle 20 rotated to its maximum gripping position for engaging a more severely stripped nut.

It will be understood by those skilled in the art that the orientation of wrench 10 can simply be reversed to change its function from loosening to tightening a nut. Irregular cam point 62′ is accordingly located on the neutral stop side of the box head.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been conveniently and widely used to describe new and useful improvements in science and the useful arts. The scope of the invention supported by the above disclosure should accordingly be construed within the scope of what it teaches and suggests to those skilled in the art, and within the scope of any claims that the above disclosure supports in this application or in any other application claiming priority to this application.

1. A box wrench for tightening and loosening both undamaged and stripped nuts, comprising:
a handle with a box head pivotally mounted at a pivot point near the end of the handle;
the box head comprising an inner gripping ring comprising a point contour of nut-engaging points and depressions, wherein a first major portion of the gripping ring is fixed relative to the box head and is interrupted by an aperture in the lower portion of the box head, and wherein a tip of the wrench handle extends above the pivot point through the aperture to the gripping ring; and,
wherein the tip of the wrench handle is contoured to define a second minor rocker portion of the gripping ring, the rocker portion movable with the handle relative to the box head and having an asymmetric point contour that completes and cooperates with the fixed portion of the gripping ring to grip a nut.

2. The wrench of claim 1, wherein the handle has a neutral position relative to the box head with the rocker tip of the handle positioned such that the asymmetric point contour forms a circumferentially aligned regular continuation of the fixed major portion of the gripping ring; and,
wherein the handle has a cam position relative to the box head with the rocker tip of the handle positioned such that the asymmetric point contour of the rocker tip is rotated out of circumferential alignment with the main fixed portion of the gripping ring and enters an interior space of the gripping ring.

3. The wrench of claim 2, wherein the asymmetric point contour at the rocker tip of the handle comprises a first higher irregular point with a radiused upper cam surface and a vertical outer side edge, and a second lower regular point with a with an outwardly angled outer side edge.

4. The wrench of claim 3, wherein the aperture comprises a first longer stop surface on one side of the aperture engaged by the rocker tip in the neutral position, and a second shorter stop surface on an opposite side of the aperture engaged by the rocker tip in the cam position.

5. The wrench of claim 4, wherein the first longer stop surface and the second shorter stop surface diverge toward a bottom of the aperture.

6. The wrench of claim 4, wherein the first longer stop surface is engaged by the first higher irregular point in the neutral position, and wherein the second shorter stop surface is engage by the second lower regular point in the cam position.
